(19) United States
(12) Patent Application Publication
(10) Pub. No.: US 2010/0079415 A1
(43) Pub. Date: Apr. 1, 2010

(54) INPUT DEVICE OF VEHICLE

(75) Inventor: Hyun Seung Yang, Gyeonggi-do (KR)

Correspondence Address: EDWARDS ANGELL PALMER & DODGE LLP, P.O. BOX 55874, BOSTON, MA, 02205, US

(73) Assignees: HYUNDAI MOTOR COMPANY, Seoul (KR); KIA MOTORS CORPORATION, Seoul (KR)

(21) Appl. No.: 12/534,196

(22) Filed: Aug. 3, 2009

(30) Foreign Application Priority Data
Sep. 30, 2008 (KR) 10-2008-0096188

(51) Int. Cl. G06F 3/033

(52) U.S. Cl. 345/184

(57) ABSTRACT

The present invention discloses a technology which arranges a direct access key and a hot key or the like according to frequency of use centering around a jog dial such that a user interface (UI) can be simplified in a driver information system.

### CROSS-REFERENCE TO RELATED APPLICATION

This application claims under 35 U.S.C. §119(a) the benefit of Korean Patent Application No. 10-2008-0096188 filed Sep. 30, 2008, the entire contents of which are incorporated herein by reference.

### BACKGROUND OF THE INVENTION

The present invention relates, in part, to an input unit for a vehicle. In particular, the present invention relates to an input unit of a vehicle which preferably arranges a direct access key and a hot key or the like according to frequency of use centering around a jog dial, such that a user interface can be suitably simplified in a driver information system.

Preferably, the present invention features a multimedia artificial intelligence vehicle that makes use of technology which suitably allows a vehicle to be a more safe and comfortable high-technology moving space. The present invention also features a vehicle comprising information and communications technology, wherein in preferred embodiments the vehicle comprises an advanced information instrument and a corresponding visible and invisible type multimedia information technology. In preferred embodiments, electric, electronic and information and communications technology are combined with the vehicle.

Preferably, the safe, secure and intelligent technology will provide a comfortable and convenient vehicle which readily provides information needed to a driver due to the advancement of multimedia technology on vehicle networks. Such an exemplary vehicle is preferably followed by the development of information transfer technology with a driver.

Preferably, the display apparatus inside of a vehicle is used not only to watch TV, but is also core hardware for a HMI (Human Machine Interface) which preferably provides useful information to a driver such as, but not limited to, the state of a vehicle, facilitating device control, navigation and telematics or the like.

Due to the complex and varying driving patterns of vehicles, preferably, extensive handling and control is required by a driver and considerable feedback is needed from inside and outside the vehicle. For example, this involves numerous kinds of information, for example, but not limited to, voice, data, image, and diagram or the like. Generally, a user interface UI includes all information related systems that are designed to interact with a user such as a display screen, keyboard, mouse, light pen, desktop type, text, and help or the like. In the present invention, in preferred embodiments the user interface (UI) is meant to refer to a method that an application or a website interacts or reacts to.

In preferred embodiments, a driver information system (DIS) provides a suitable function to check whether a car door is properly locked and controls an electric and electronic system of a vehicle which preferably can be checked using a mobile phone. In preferred embodiments of the invention, such driver information system is a technology in which network technology for vehicles is suitably integrated, and preferably it is a technology which suitably connects many types of multimedia devices (i.e., audio system, Global Positioning System, DVD or the like) and an electronic control unit air conditioning system, seat, steering wheel or the like with digital technology.

Preferably, the driver information system can suitably control various multimedia devices by a single monitor and can automatically control a seat and steering wheel and can suitably a number of instruments of a vehicle preferably using a mobile telephone. According to the present invention, the driver information system preferably replaces a plurality of buttons which are generally used in a vehicle with a jog-dial and suitably simplifies the user interface UI. Preferably, a complex form of a multiple direction joystick and rotary dial, and push-button can suitably be used for such jog dial. Preferably, as the number of menu items increases, and more input buttons are needed to input data, such as a character input, the arrangement of the interface becomes an important consideration.

The above information disclosed in this Background section is only for enhancement of understanding of the background of the invention and therefore it may contain information that does not form the prior art that is already known in this country to a person of ordinary skill in the art.

### SUMMARY OF THE INVENTION

In one aspect, the present invention provides an input unit of a vehicle which can suitably simplify a user interface (UI) in a driver information system (DIS) by using a direct access key, a jog dial, and a hot key. In particular preferred embodiments, the present invention preferably provides an input unit of a vehicle which can suitably improve a user interface (UI) in a driver information system (DIS) by providing a direct access key and a hot key according to frequency of use centering around a jog dial.

In preferred embodiments, an input unit of vehicle according to the present invention preferably includes a multi-switch which has a dial function, joystick function and push function, and preferably performs a menu movement and screen focus movement in a menu list suitably displayed on a screen; and a plurality of direct access buttons which are preferably arranged around the multi-switch according to frequency of use, and suitably performs a function selected by the multi-switch.

In accordance with preferred embodiments of the present invention, the plurality of direct access buttons preferably includes a wheel button which has a low frequency of use, and moves the function list; and a plurality of push-buttons which has a high frequency of use, and performs a specific function or performs a selected function. Preferably, the function list is displayed on an additional display window of the screen when the wheel button is manipulated. Preferably, the screen indicates a function of the plurality of direct access buttons. Preferably, the dial function suitably selects a menu list movement, enlargement and reduction function, the joystick function suitably selects a focus movement and a focus movement between right and left menu in a navigation map, and the push function suitably performs a selected function, confirmation, play, pause, start, and storage. Preferably, the screen comprises a touch mode conversion button which changes to a touch mode.

In preferred embodiments, the present invention has an effect of suitably simplifying the user interface in the driver information system by preferably providing a direct access key, jog dial, and hot key. Further, the present invention has an effect of suitably improving the user interface in the driver information system by preferably arranging the direct access key and the hot key according to frequency of use centering around the jog dial.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum).

As referred to herein, a hybrid vehicle is a vehicle that has two or more sources of power, for example both gasoline-powered and electric-powered.

The above features and advantages of the present invention will be apparent from or are set forth in more detail in the accompanying drawings, which are incorporated in and form a part of this specification, and the following Detailed Description, which together serve to explain by way of example the principles of the present invention.

### BRIEF DESCRIPTION OF THE DRAWINGS

The above and other features of the present invention will now be described in detail with reference to certain exemplary embodiments thereof illustrated by the accompanying drawings which are given hereinafter by way of illustration only, and thus are not limitative of the present invention, and wherein:

FIG. 1 is a conceptual diagram showing an input unit of a vehicle as described in preferred embodiments of the preset invention.

FIGS. 2a and 2b are drawings showing an application example of a wheel button 22.

FIGS. 3a and 3b are drawings showing an application example of a first and a second soft button 24, 26.

FIG. 4 is a drawing showing an application example of an eight direction function of a jog dial 10.

FIGS. 5a and 5b are drawings showing an application example of a dial function and a push function of a jog dial 10.

FIGS. 6a to 6c are drawings showing an application example in which an input unit of a vehicle of the present invention uses a touch mode.

FIGS. 7a to 7e are drawings showing an application example in which an input unit of a vehicle of the preset invention partly uses a touch mode.

FIG. 8 is a conceptual diagram showing another preferred embodiment of an input unit of a vehicle of the present invention.

FIG. 9 is a drawing showing a stand-by screen when a phone button 330 is pushed.

FIG. 10 is a drawing showing a map of navigation mode when a map button 340 is pushed.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use in the environment.

### DETAILED DESCRIPTION OF THE EMBODIMENTS

As described herein, the present invention includes an input unit of a vehicle, comprising a multi-switch which includes a dial function, joystick function and push function, and a plurality of direct access buttons.

In one embodiment, the multi-switch performs a menu movement and screen focus movement on a menu list displayed on a screen.

In another embodiment, the plurality of direct access buttons are arranged around the multi-switch according to frequency of use.

In another further embodiments, the plurality of direct access buttons performs a function selected by the multi-switch.

In a related embodiments, the plurality of direct access buttons further comprises a wheel button.

In another embodiment, the plurality of direct access buttons further comprises a plurality of push-buttons.

In another further embodiment, the wheel button has a low frequency of use, and selects the function.

In still another embodiment, the plurality of push-buttons have a high frequency of use, and performs a specific function or a selected function.

The invention also features a motor vehicle comprising the input unit of a vehicle as described in any one of the aspects herein.

Hereinafter, exemplary embodiments of the present invention will be described in detail with reference to the attached drawings.

According to preferred embodiments, the present invention discloses a technology which can suitably simplify a user interface in a driver information system by preferably providing a direct access key and a hot key.

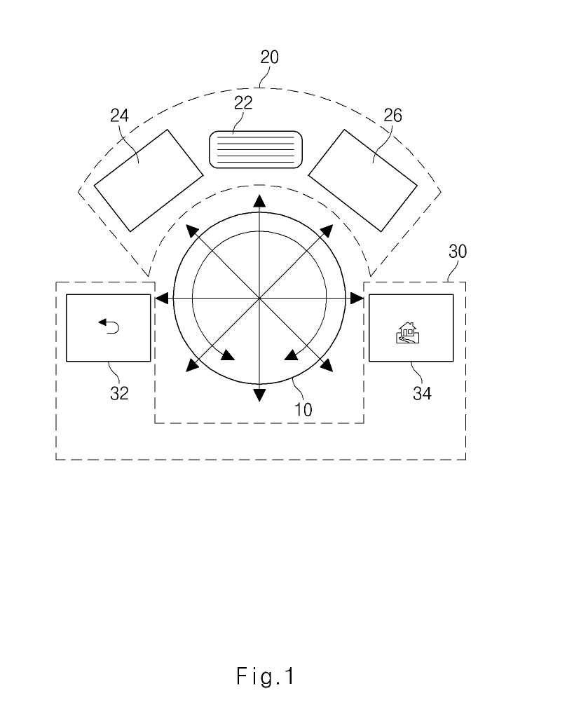

According to certain embodiments of the invention and as shown in FIG. 1, FIG. 1 is a conceptual diagram showing an input unit of a vehicle of the present invention.

In preferred embodiments, the input unit of a vehicle preferably includes a jog dial 10, direct access key 20, and hot key 30. Preferably, the jog dial 10 includes a dial function that suitably selects a menu selection movement, an enlargement or a reduction, an eight direction joystick function that suitably selects a map movement and a focus movement between right and left menu, and a push function that suitably selects a function selection, a confirmation, play/pause, start, and save.

According to further preferred embodiments of the invention, the direct access key 20 is preferably located in the upper portion centering around the jog dial 10 according to frequency of use, and preferably includes a wheel button 22 which allows the selection of an option function on the center of the screen, and a first and a second soft button 24, 26 which preferably allows the selection of a function on the screen on the right and left respectively.

According to further exemplary embodiments, the wheel button 22 can preferably be used to select a context menu in navigation mode, user settings from the main mode, BSM (Best Station Memory) and a preset list for the radio. Preferably, the first soft button 24 can be used to suitably select a location registration in the navigation mode, a selection mode currently playing in the main mode, and seek down for the radio. Preferably, the second soft button 26 can be used to suitably select neighboring facilities in the navigation mode, the current location of navigation in the main mode, and seek up for the radio. Preferably, the hot button 30 is suitably located at both sides of the jog dial 10, and includes a back button 32 which when suitably pressed moves to a previous upper menu and a home button 34 which when suitably pressed goes back to the main menu. According to further embodiments, if necessary, a phone button and a navigation map button can preferably be additionally included.

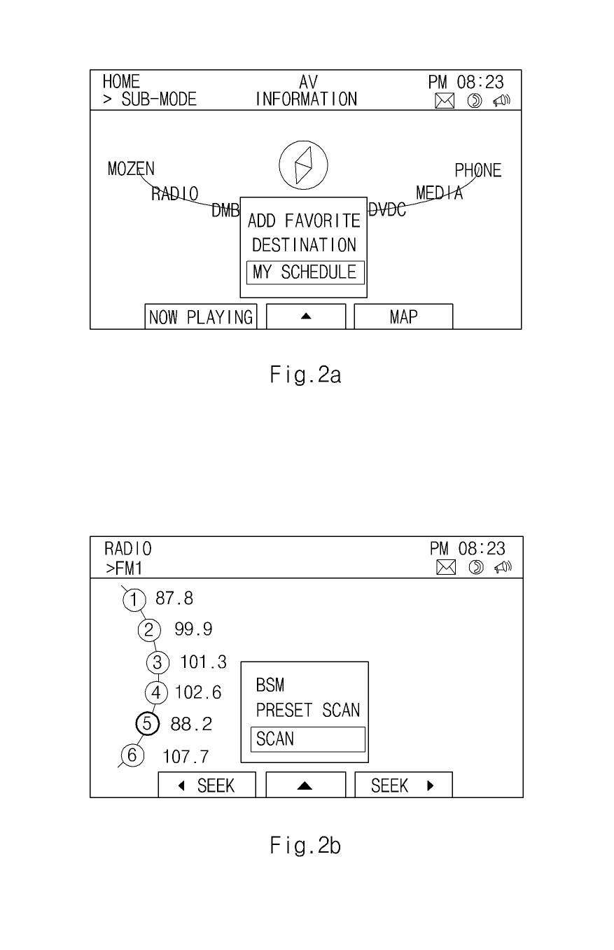

According to other further embodiments and as shown in FIG. 2, FIGS. 2a and 2b are drawings showing an application example of a wheel button 22. In one embodiment, FIG. 2a shows a favorite function which is a user setting function in the main mode. In another embodiment, FIG. 2b shows an option function such as BSM, preset scan, and scan for the radio mode. Accordingly, the wheel button 22 suitably hides functions which are complex and not frequently used in the screen, and suitably indicates this in an additional display window when it is selected, such that the screen and the button can be concisely implemented.

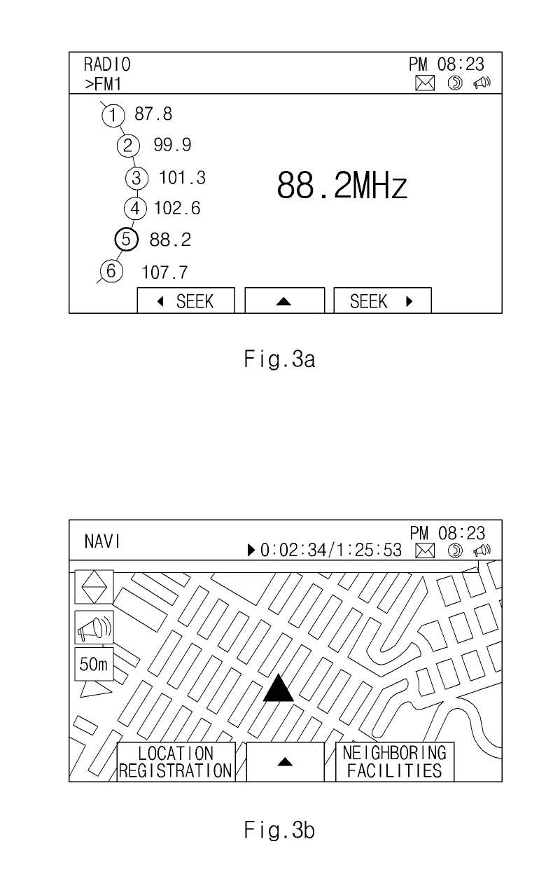

According to other further embodiments and as shown in FIG. 3, FIGS. 3a and 3b are drawings showing an application example of a first and second soft button 24, 26. In one embodiment, FIG. 3a shows seek up/seek down function in radio mode. In another embodiment, FIG. 3b shows a location registration and neighboring facilities selection function in navigation mode. In further preferred embodiments, the function of the first and the second soft button 24, 26 is suitably indicated on the screen for driver convenience.

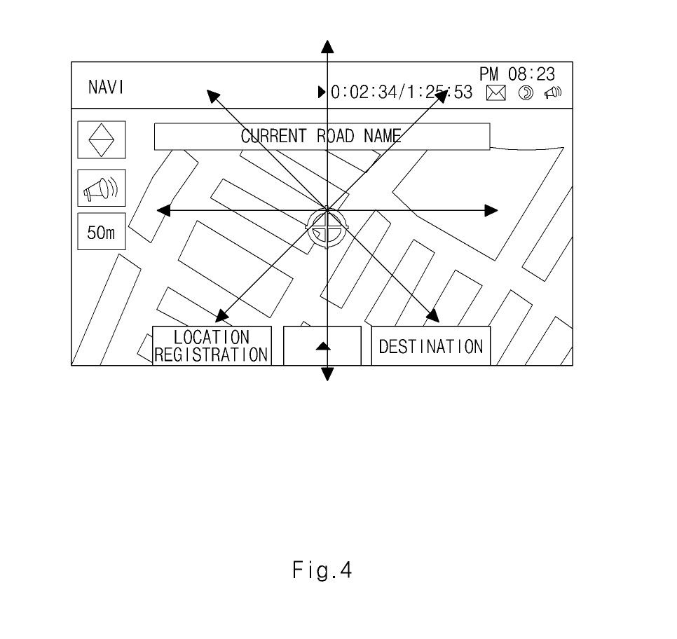

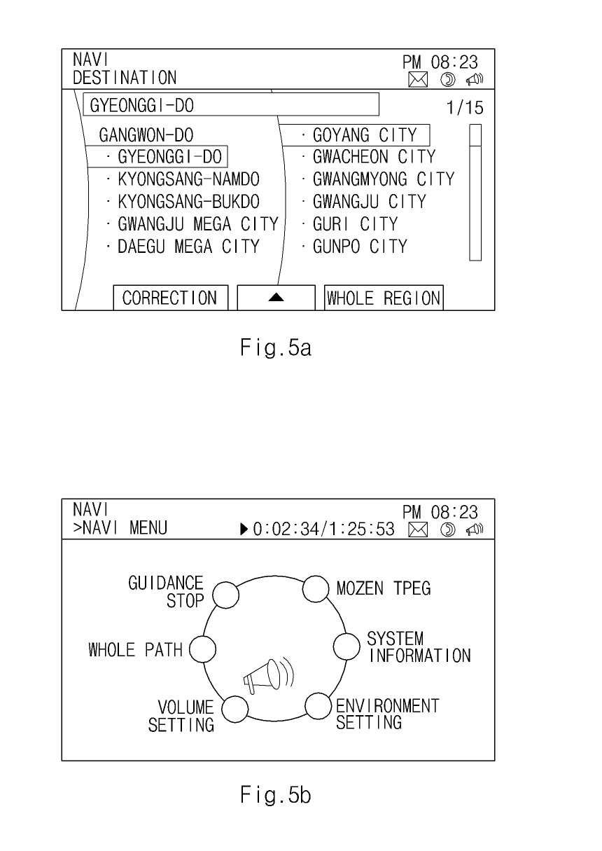

According to other further embodiments and as shown in FIG. 4, FIG. 4 is a drawing showing an application example of an eight direction function of a jog dial 10 according to exemplary embodiments of the present invention, showing a screen transfer function in navigation mode. According to other further embodiments and as shown in FIG. 5, FIGS. 5a and 5b are drawings showing an application example of a dial function and a push function of a jog dial 10. FIG. 5a shows a mode for suitably inputting an address in navigation mode, and FIG. 5b shows a mode for suitably selecting a menu in navigation mode. In further preferred embodiments, the dial function moves an address list, and a menu list, while the push function can preferably be selectively chosen.

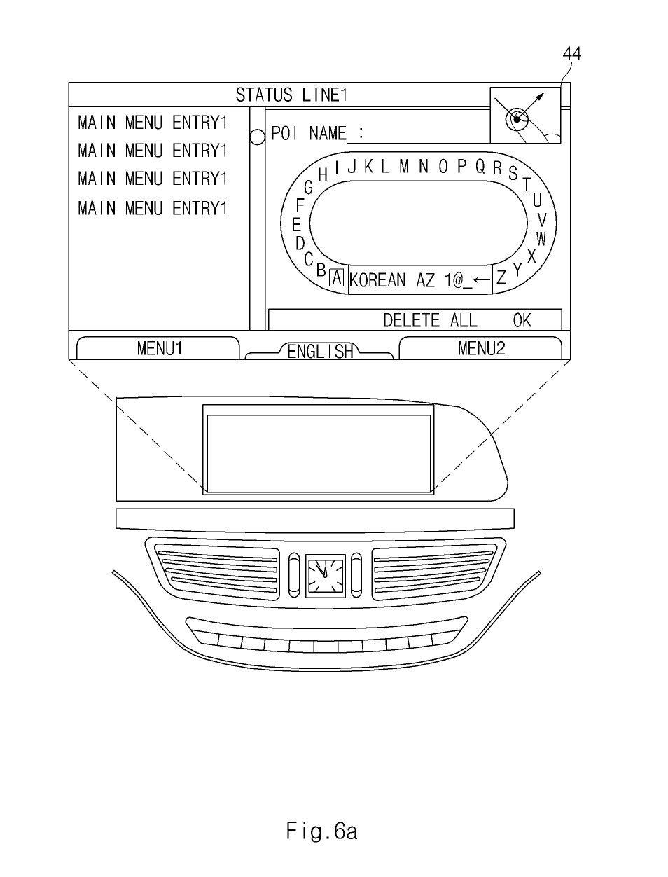

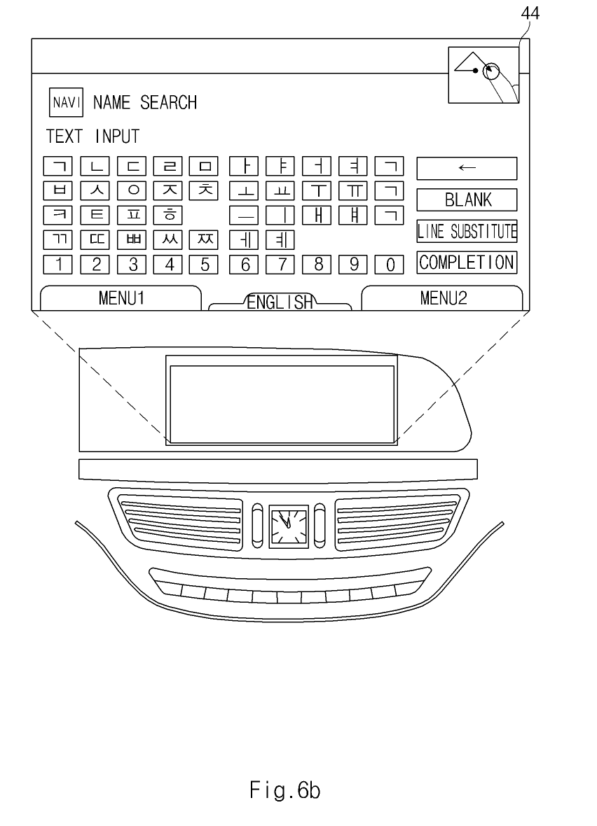

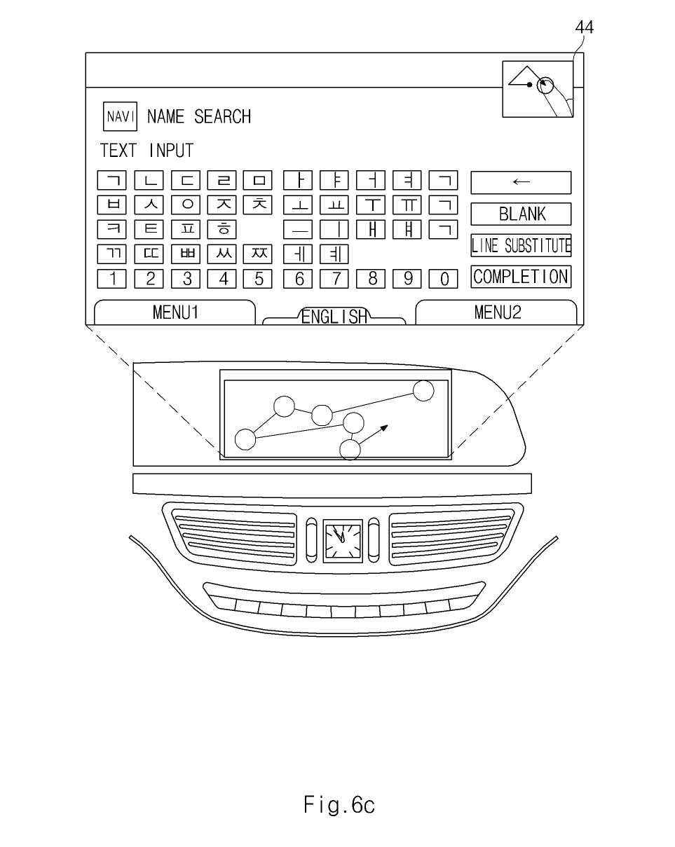

According to other further embodiments and as shown in FIG. 6, FIGS. 6a to 6c are drawings showing a preferred application example in which an input unit of a vehicle of the present invention has a suitable touch mode that is chosen. In certain exemplary embodiments, FIG. 6a shows a preferred operation of suitably touching a touch mode icon 40 on the screen so as to enter touch mode among various possible system operations. According to other exemplary embodiments, FIG. 6b shows the state on a screen entering the touch mode. According to still other further embodiments, FIG. 6c shows the state of terminating the touch mode by suitably pushing a touch mode completion button 44.

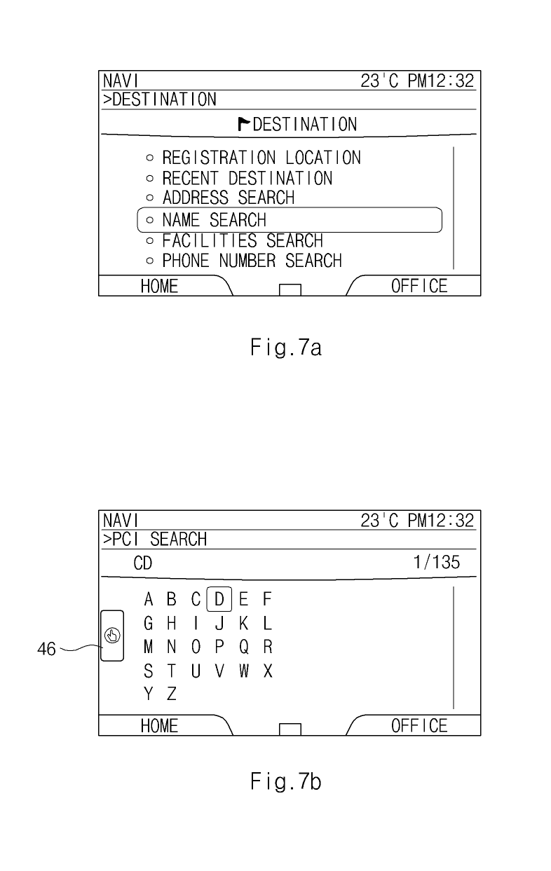

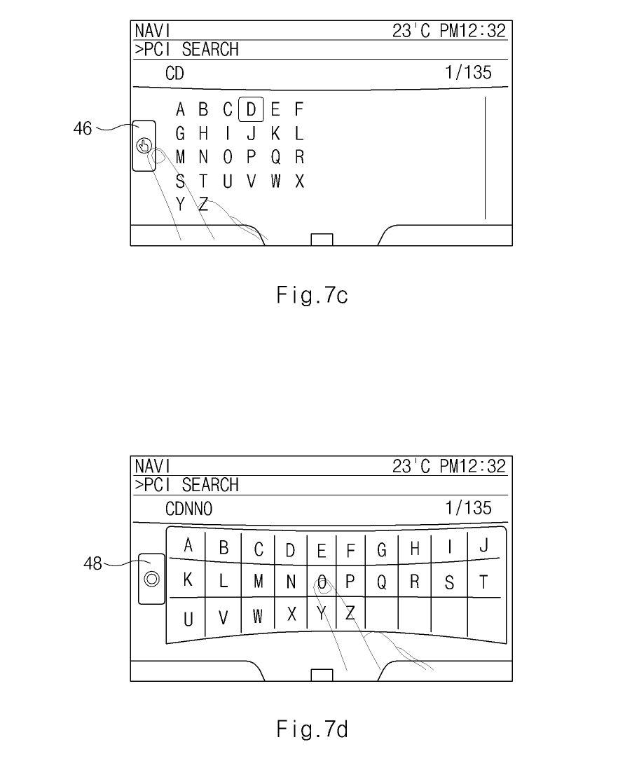

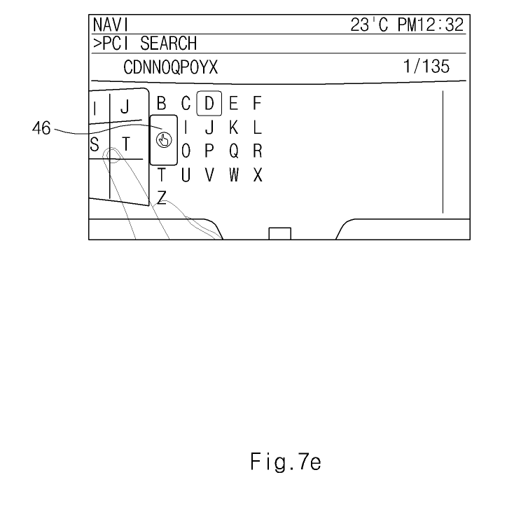

According to other further embodiments and as shown in FIG. 7, FIGS. 7a to 7e are drawings showing a preferred application example in which an input unit of a vehicle of the present invention preferably uses a touch mode.

According to preferred embodiments, FIG. 7a shows a screen where a name search function to search a destination in navigation mode is suitably selected. According to other preferred embodiments, FIG. 7b shows the case of suitably manipulating a word by using a concentration manipulation system 10, 20, 30 of a center console while suitably displaying at a user interface (UI) of a screen in the navigation mode in order to input the name of a destination. According to still other preferred embodiments, FIG. 7c shows the case of suitably touching a touch mode icon 46 on the screen by a finger as the step that manipulates the word by using the concentration manipulation systems 10, 20, 30 may in certain cases be cumbersome. According to certain preferred embodiments, FIG. 7d shows an example in which the screen is suitably converted to the touch mode. According to other preferred embodiments, FIG. 7e shows an example of returning to a screen which suitably indicates the user interface UI by preferably touching a touch mode completion icon 44 illustrated in FIG. 7d to suitably terminate the touch mode.

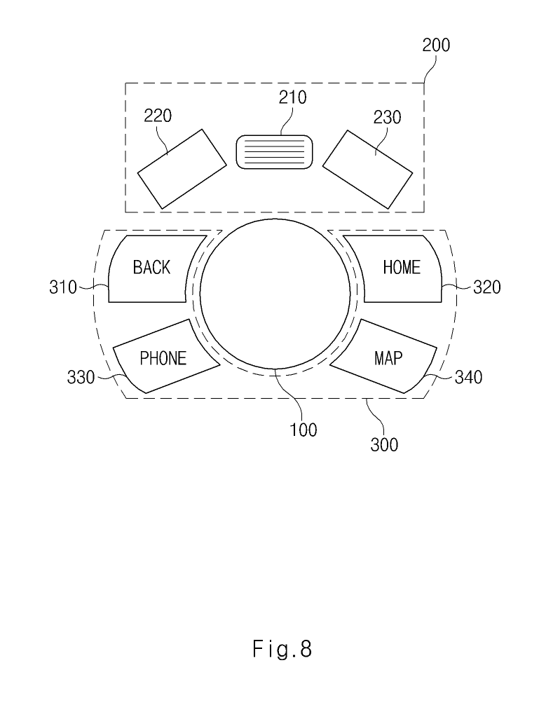

According to other further embodiments and as shown in FIG. 8, FIG. 8 is a conceptual diagram showing another preferred embodiment of an input unit of a vehicle of the present invention.

In certain preferred embodiments of the invention as described herein, the input unit of a vehicle preferably includes, but is not limited only to, a jog dial 100, direct access key 200 and hot key 300. Preferably, the jog dial 100, wheel button 210 of the direct access key 200 and first and second soft buttons 220, 230 are suitably identical with the function of the jog dial 10 and the access key 20 illustrated in FIG. 1, thus, a detailed description of them is omitted.

According to preferred embodiments, the hotkey 300 is preferably located at both sides of the jog dial 10 (or lower portion), including a back button 310 which when suitably pressed goes to a previous upper menu, a home button 320 which when suitably pressed goes to a main menu, a phone button 330 for making a phone call, and a map button 340 which suitably indicates a current position from the navigation mode.

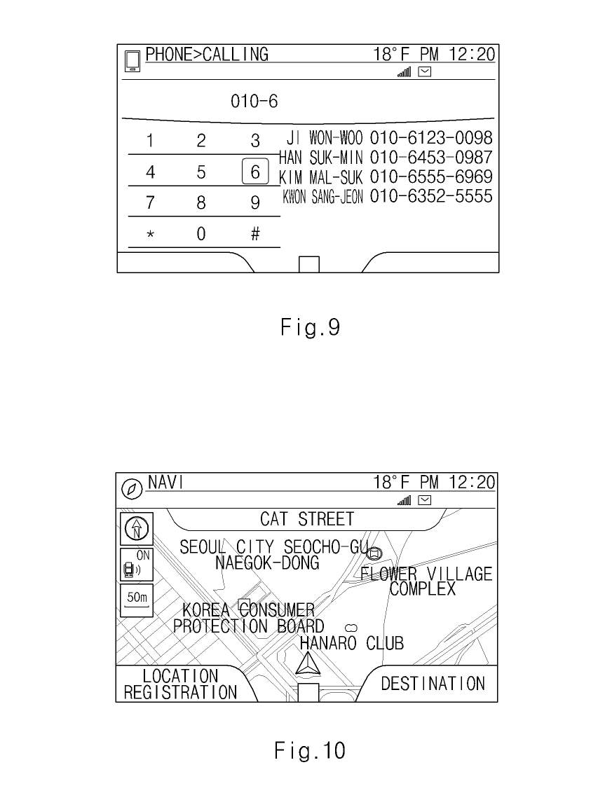

According to other further embodiments and as shown in FIG. 9, FIG. 9 is a drawing showing a stand-by screen when a phone button 330 is suitably pushed. According to still other further embodiments and as shown in FIG. 10, FIG. 10 is a drawing showing a map screen of navigation mode when a map button 340 is suitably pushed.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. An input unit of a vehicle, comprising:
a multi-switch which includes a dial function, joystick function and push function, and performs a menu movement and screen focus movement on a menu list displayed on a screen; and
a plurality of direct access buttons which are arranged around the multi-switch according to frequency of use, and performs a function selected by the multi-switch.

2. The input unit of a vehicle of claim 1, wherein the plurality of direct access buttons comprises:
a wheel button which has a low frequency of use, and selects the function; and
a plurality of push-buttons which has a high frequency of use, and performs a specific function or a selected function.

3. The input unit of a vehicle of claim 2, wherein the function is displayed on an additional display window of the screen when the wheel button is manipulated.

4. The input unit of a vehicle of claim 1, wherein the screen indicates a function of the plurality of direct access buttons.

5. The input unit of a vehicle of claim 1, wherein the dial function selects a menu list movement, enlargement and reduction function, the joystick function selects a focus movement and a focus movement between right and left menu in a navigation map, and the push function performs a selected function, confirmation, play, pause, start, and storage.

6. The input unit of a vehicle of claim 1, wherein the screen comprises a touch mode conversion button which changes a made of the screen to a touch mode.

7. An input unit of a vehicle, comprising:
a multi-switch which includes a dial function, joystick function and push function; and
a plurality of direct access buttons.

8. The input unit of a vehicle of claim 7, wherein the multi-switch performs a menu movement and screen focus movement on a menu list displayed on a screen.

9. The input unit of a vehicle of claim 7, wherein the plurality of direct access buttons are arranged around the multi-switch according to frequency of use.

10. The input unit of a vehicle of claim 7, wherein the plurality of direct access buttons performs a function selected by the multi-switch.

11. The input unit of a vehicle of claim 7, wherein the plurality of direct access buttons further comprises a wheel button.

12. The input unit of a vehicle of claim 7, wherein the plurality of direct access buttons further comprises a plurality of push-buttons.

13. The input unit of a vehicle of claim 11, wherein the wheel button has a low frequency of use, and selects the function.

14. The input unit of a vehicle of claim 12, wherein the plurality of push-buttons have a high frequency of use, and performs a specific function or a selected function.

15. A motor vehicle comprising the input unit of a vehicle of claim 1.

16. A motor vehicle comprising the input unit of a vehicle of claim 7.
